(19) United States
(12) Patent Application Publication
(10) Pub. No.: US 2026/0296356 A1
(43) Pub. Date: Oct. 1, 2026

(54) AIRBAG DEVICE

(71) Applicant: Autoliv Development AB, Vargarda (SE)

(72) Inventors: Johann UNGER, Dachau (DE); Ridvan ORAL, Altomünster (DE); Marc SCHOCK, Karlsfeld (DE); Torsten SCHLENK, Dachau (DE); Thomas REITER, Vierkirchen (DE)

(21) Appl. No.: 19/480,629

(22) PCT Filed: May 16, 2024
(86) PCT No.: PCT/EP2024/063556

§ 371 Date: Oct. 31, 2025

(30) Foreign Application Priority Data
May 22, 2023 (DE) 10 2023 113 341.1

(51) Int. Cl. B60R 21/233; B60R 21/2342; B60R 21/235; B60R 21/239; B60R 21/264

(52) U.S. Cl. CPC B60R 21/233; B60R 21/2342; B60R 21/235; B60R 21/239; B60R 21/264; B60R 2021/23538

(57) ABSTRACT

An airbag device for the two-stage deployment of a first and a second gas chamber, comprising a first system comprising the first gas chamber and a first gas generator which is triggered in a pre-accident situation; and a second system comprising the second gas chamber and a second gas generator which is triggered in an accident situation; wherein the first system is configured to fill the first gas chamber with gas by means of the first gas generator wherein-the second system is configured to fill the second gas chamber with gas by means of the second gas generator.

The present invention relates to an airbag device for the two-stage deployment of a first and a second gas chamber.

Various airbag devices are well known from the prior art.

The object of the invention is to provide an improved airbag device.

The object is achieved by the features of the independent claims. Further preferred embodiments of the invention are found in the dependent claims, the figures and the associated description.

The object is achieved by an airbag device for the two-stage deployment of a first and a second gas chamber, comprising a first system comprising the first gas chamber and a first gas generator that is triggered in a pre-accident situation; and a second system comprising the second gas chamber and a second gas generator that is triggered in an accident situation; wherein the first system is configured to fill the first gas chamber with gas by means of the first gas generator, wherein the second system is configured to fill the second gas chamber with gas by means of the second gas generator. This means that the first gas chamber is filled first and then the second gas chamber is filled.

The proposed airbag device is used according to its first use as a pre-airbag system. In this case, the first gas chamber is filled with gas before the occurrence of a foreseeable accident event, preferably approximately 200 ms before the time of the accident t=0. The first system allows a passenger to be relocated laterally away from a door, for example, before the unavoidable accident time t=0, in order to create better conditions in the event of a severe lateral impact. This is necessary because in the event of a particularly severe lateral impact, the gap available for the complete deployment of the second gas chamber would close prematurely and would preclude complete filling and positioning of the second gas chamber. This would result in only a reduced or no protective effect of the normal system. The second system protects the passenger using the second gas chamber; this is comparable to the protective effect of a conventional airbag. The second system is filled and positioned within preferably approximately 20 ms.

Preferably, the first gas chamber has a smaller internal volume than the second gas chamber. This allows the first gas chamber to be filled more quickly. Since this preferably also has a highly tight seal compared to the second gas chamber, it can also be used to implement a supporting effect with which a passenger can be moved into an advantageous position.

It is further proposed that the second gas chamber be formed by sewing a layer onto the first gas chamber (31). The layer of the first gas chamber accordingly forms one side of the second gas chamber; this is then sewn to a further fabric layer to form the second gas chamber. For example, there is also a ventilation opening on this fabric layer. This combined formation of the first and second gas chamber allows for a more compact design.

It is further proposed that the second gas chamber be connected to the first gas chamber by a seam, wherein the first gas chamber is formed by a double layer,
wherein
the double layer of the first system is used as an additional sealing strip for the first and/or the second gas chamber. In order to improve the tightness of the seams of the second gas chamber, the first gas chamber is constructed in two layers in the regions of the sealing seams. One layer also acts as a sealing strip. This can reduce costs in the production of the airbag. This combination of the first gas chamber with an additional fabric layer allows the airbag device to be easily folded, and takes up little space. The system function of both systems can be individually adjusted to the desired parameters of the given system by volume, dimensioning of the ventilation opening, internal pressure in the gas chambers and performance of the gas generators. This also simplifies the simulation of the airbag device. Overall, the result is a system that offers significantly improved passenger protection than conventional airbag systems, especially in particularly serious accident situations.

Preferably, the external geometries of the first gas chamber and the second gas chamber are identical or nearly identical. This means that the first gas chamber can be used particularly well to unfold the second gas chamber.

It is further suggested that the first gas generator is a cold gas generator and/or the second gas generator (13) is a pyrotechnic gas generator. The first system is advantageously filled by a cold gas generator due to the long required internal pressure persistence time of approx. 200 ms, and must therefore be designed to be very tight at a low pressure of approx. 0.5 bar. The second system is filled very quickly, in approximately 20 ms, and preferably begins energy absorption immediately through a ventilation opening of approximately 20 mm in diameter. The pressure occurring in the system during intrusion is significantly higher than in the first load case, and can be up to 2 bar. This filling can be carried out particularly advantageously using a pyrotechnic gas generator.

It is further proposed that the airbag device comprise a seat covering and/or a housing, wherein the first and the second gas chamber are arranged in the seat covering and/or within the housing in the deactivated state, wherein the first system is configured to open the seat covering and/or the housing upon activation, and/or the first system is configured to pre-deploy the second gas chamber upon activation. The first gas chamber opens the seat covering with its internal pressure and provides sufficient volume to displace the passenger in the time window t<0. In order to guarantee sufficient pre-positioning of the second gas chamber for the normal load case t>0, the first gas chamber also has air bridges that are not necessary for its actual function. They serve to fully pre-deploy the second gas chamber for normal function. This has the advantage that the seat covering does not have to be opened for the normal airbag function of the second gas chamber and the second gas chamber is already pre-deployed. This means that the second gas generator can be smaller, and less energy is required.

Secondly, the interaction with the already filled first gas chamber results in an earlier complete filling of the second system. Due to the higher internal pressure of the second gas chamber, the volume of the first gas chamber is significantly reduced, but there is no energy loss for the overall system.

The interaction of both systems results in significant advantages over a conventional side airbag system. A significant advantage is the guaranteed safety of the passenger with regard to the function of the second gas chamber, since the positioning of the first gas chamber is ensured in all accidents, even in very serious ones, by the deployment of the first gas chamber before t<0. The connection of the second fabric layer, which is required to form the second gas chamber, with the first gas chamber takes place in areas that are not required for filling the first gas chamber.

It is further proposed that the first gas chamber comprise a plurality of air bridges for the complete pre-deployment of the second gas chamber. The air bridges allow for a comparatively small volume of the first gas chamber.

It is further proposed that the second gas chamber comprise a valve opening for discharging gas from the second gas chamber. This enables sufficient energy absorption.

It is further proposed that the first and second gas generators be arranged in the first gas chamber. This enables a compact design of the airbag device.

It is further proposed that the first gas chamber be designed as a single-piece woven structure, and preferably have an inwardly foldable sealing region in a region of the first gas generator assigned to the first gas chamber. This allows the airbag device to be designed to be particularly reliable.

It is further proposed that the interior of the second gas chamber be fluidically separated from the environment by a seam, wherein the second gas chamber is designed in two layers in order to provide additional sealing of the seam by the second layer. This increases the quality of the seal and thus the system reliability.

It is further proposed that the first gas chamber comprise non-inflatable regions through which a tear seam for the second gas chamber can be placed without affecting the filling of the first gas chamber. It is further proposed that the first gas chamber have non-inflatable regions through which a ventilation opening for the second gas chamber can be placed without affecting the function of the first system. This means that the non-inflatable areas can be used additionally.

It is further proposed that the second gas chamber have a sealed inlet for the second gas generator, which is additionally designed with a thermal reinforcement layer. This ensures efficient and reliable inflation.

It is further proposed that the second gas chamber comprise a ventilation opening which is additionally connected to the first system by a tear seam. The valve opening in the second gas chamber can be closed off by the tear seam until it is completely filled. In this case, the tear seam is preferably made through the regions of the first system that are not required.

The impulse transmitted to the passenger by the intrusion into the vehicle in the event of an accident is attenuated to the passenger by the ventilation of the airbag device, and the passenger is displaced further into the interior within biomechanically permissible limits. The active exposure time is a maximum of 40 ms at high internal pressure in the system.

It is further proposed that the first and the second gas chamber be formed by the same airbag, wherein the first and the second gas chamber are not fluidically connected to each other during the pre-accident phase, and the first gas chamber is filled by the first gas generator.

It is further proposed that the first and the second gas chamber be formed by the same airbag into which both gas generators are integrated, wherein the second gas generator releases its gas in the event of an accident into a fabric tube into which a ventilation opening is integrated and which is fluidically separated from the actual second gas chamber by a tear seam, wherein this tear seam is opened by the resulting pressure wave when the second gas generator is ignited and then inflates the single airbag with gas.

The second, predominantly pyrotechnic gas generator, blows its generated gas preferably into a fabric tube that is separated from the second system by a tear seam. A valve opening is preferably integrated into the fabric tube. The resulting pressure wave preferably opens the tear seam to the second system and the gas fills the still partially inflated airbag. The valve opening now connected to the system ensures the desired ventilation of the system in the period t>0.

The disclosure content of this application also includes a method for the two-stage deployment of a first and a second gas chamber using the airbag device described above. Preferably, the first gas generator is activated in a first step and the second gas generator is activated in a subsequent second step.

The invention will now be described with reference to two exemplary embodiments of an airbag device, each with two gas generators.

In the Figures:

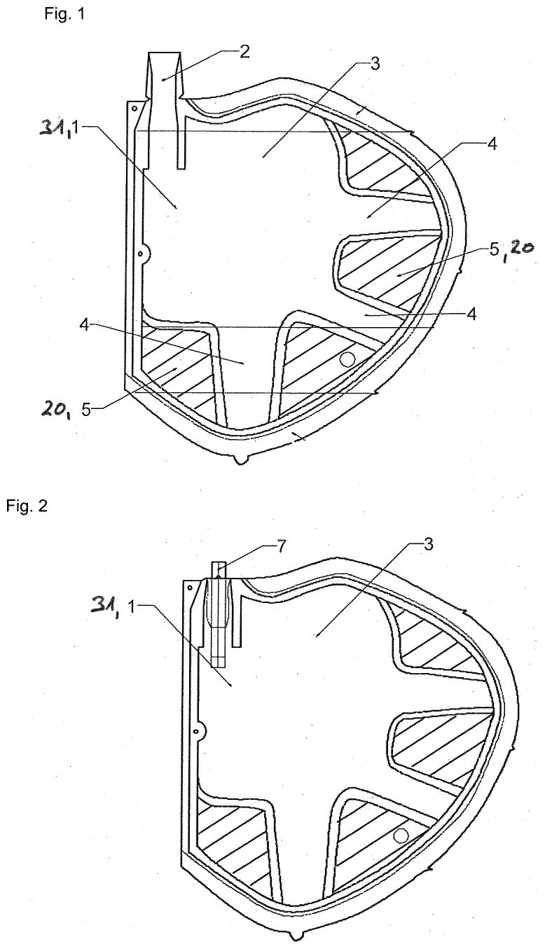

FIG. 1 is a single-piece woven airbag with additional deployment channels and sealing cuff which will be folded inward,

FIG. 2 is a single-piece woven airbag with inwardly-folded cuff and gas generator,

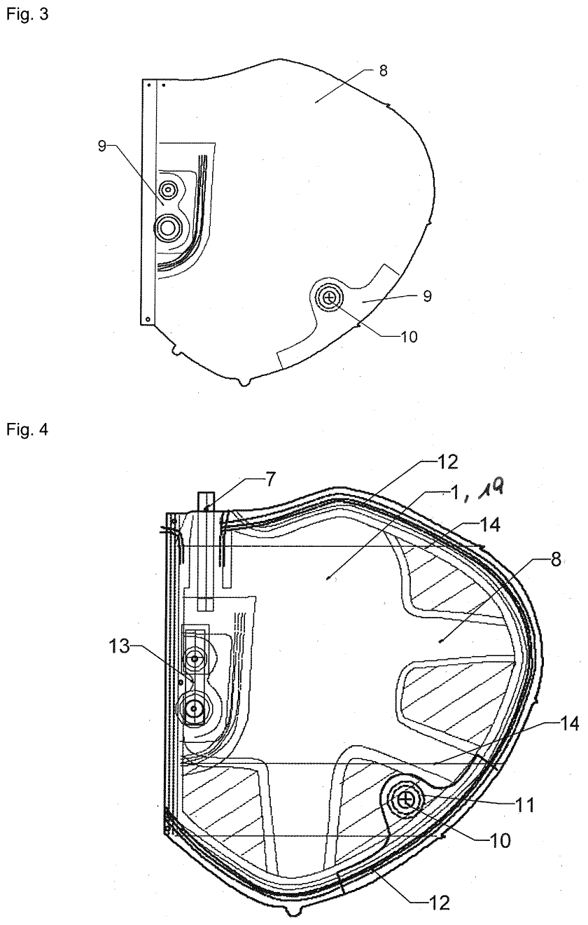

FIG. 3 is an additional fabric layer for the single-piece woven airbag to form a SAB with gas generator insertion opening, reinforcement layer, and vent,

FIG. 4 is a sewn fabric layer on the single-piece woven airbag with gas generator, reinforcement layer, and vent with tear seam,

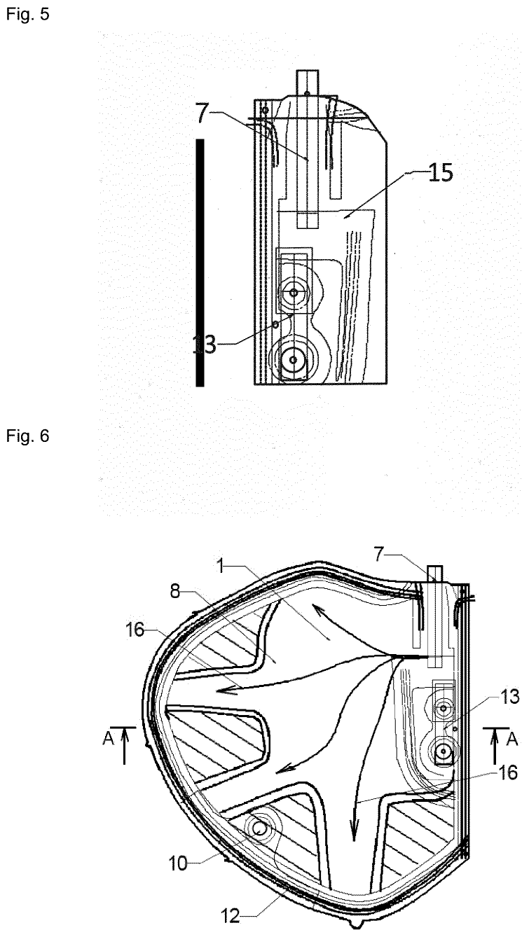

FIG. 5 is a dual SAB in a folded design,

FIG. 6 is a dual SAB with inflated airbag t<0 for relocating the passenger, with fully deployed SAB structure; view from the inside of the seat,

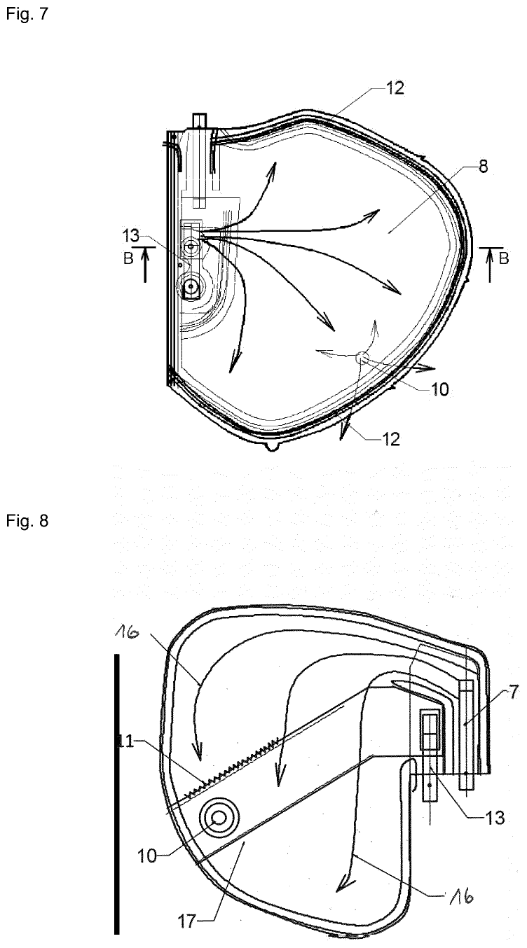

FIG. 7 is a dual SAB with filled second stage and ventilation; view from the door side,

FIG. 8 is a dual SAB formed by an airbag with two gas generators after ignition of the first gas generator t<0,

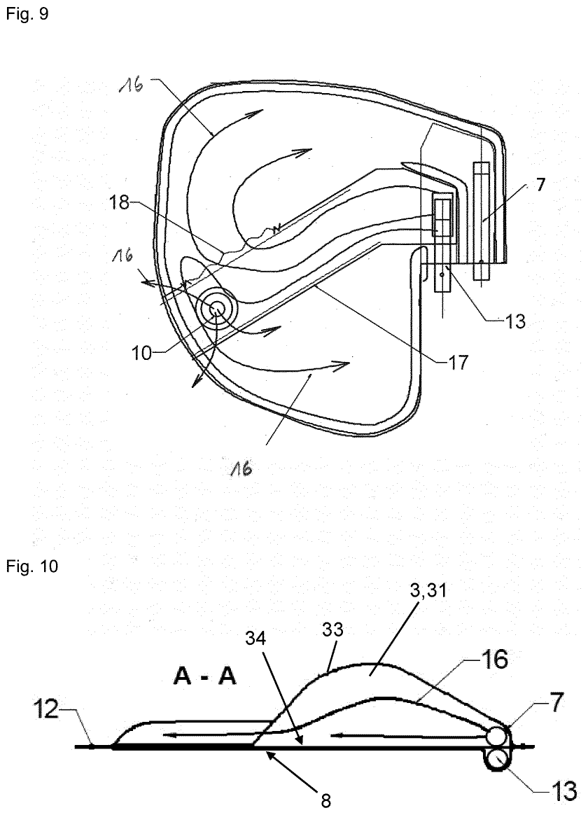

FIG. 9 is a dual SAB made of one airbag after ignition of the second gas generator t>0,

FIG. 10 is a representation of the dual SAB from FIG. 6 in the sectional direction A-A,

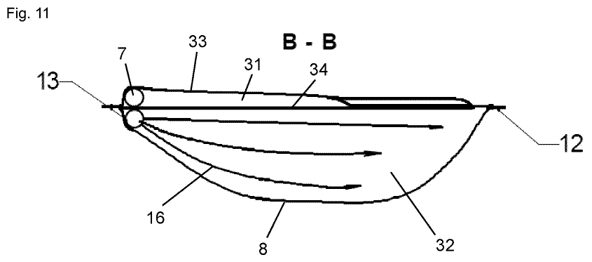

FIG. 11 is a representation of the dual SAB from FIG. 7 in the sectional direction B-B.

FIG. 1 is a first gas chamber 31 of an airbag device 19 according to the invention, which is fastened as a side airbag (SAB) in a side structure of a vehicle or a seat structure of a vehicle seat. The airbag device 19 is preferably attached to an inner side of the seat structure so that it finds support on the seat structure on its outer side, starting from the passenger. It can also be attached to the outside of the seat structure, in a B-pillar or a door structure.

When the airbag device 19 is activated, the first gas chamber 31 and a second gas chamber 32, described in more detail below, between the passenger and the inner side structure of the vehicle are inflated so that the passenger is protected from an impact with the inner side structure of the vehicle. If the airbag device 19 is mounted in the vehicle seat, the geometry of the first gas chamber 31 and the second gas chamber 32 must be designed and inflated in such a way that, when activated during inflation, the chambers tear open pre-determined tear seams in the upholstery of the vehicle seat, pass outwards through this torn tear seam and are finally inflated to the side of the passenger.

The airbag device 19 according to the invention has the first gas chamber 31, which is formed by a single-piece woven airbag 1. The first gas chamber 31 comprises two fabric layers which are woven together to form the airbag in a manufacturing process for a single-piece woven. Alternatively, the airbag 1 can also be formed by two fabric sections sewn together.

The first gas chamber 31 comprises a fillable internal volume 3, a plurality of non-inflatable regions 20 and a plurality of inflatable air bridges 4 separating the non-inflatable regions 20 from one another and extending radially outward. The non-inflatable regions 20 are preferably realized here by connecting the two fabric layers to form connected fabric sections 5.

Furthermore, the first gas chamber 31 has an inwardly-foldable sealing cuff which is folded inwards when a first gas generator 7 is inserted, and forms a seal for the first gas generator 7, as can be seen in FIG. 2.

Furthermore, an additional fabric layer 8 is provided, which can be seen in FIG. 3 and which has a reinforcement layer 9 on its left side in the region of the arrangement of a second gas generator 13, which will be described later, and a further reinforcement layer 9 in the region of a ventilation opening 10 which can be torn open via a tear seam 11. The fabric layer 8 is sewn to the outside of the first gas chamber 31 with its radially outer edge and thus encloses a second gas chamber 32 towards the outside of the first gas chamber 31.

The second gas generator 13 is also arranged in the first gas chamber 31 and can be or is connected fluidically to the second gas chamber 32 via corresponding gas lances and/or tearable ventilation openings. The fabric layers of the first gas chamber 31 and the second gas chamber 32 have an identical or almost identical outer geometry, so that the airbag device 19 is designed in three layers in the unfolded state and has an outer geometry corresponding to the outer geometry of the first gas chamber 31. The airbag device 19 is then folded with the fabric layers in the fold lines 14 shown in FIG. 4 and then further rolled or folded into a compact design shown in FIG. 5 with a cylindrically rolled or folded airbag 15.

FIG. 6 shows the inflation of the airbag device 19 in a first pre-accident phase t<0 before the occurrence of a subsequent accident by the activation of the first gas generator 7. The first gas generator 7 is implemented by a cold gas generator which, when activated, releases a cold gas flow corresponding to the gas flow 16 shown in a very short period of time without the occurrence of chemical reactions. First, the internal volume 3 of the first gas chamber 31 is filled, by means of which the passenger is held or brought into position in a first phase of restraint. If the passenger is already in his desired position, the inflated internal volume 3 serves to keep the free space between the passenger and the vehicle seat and/or the inner side structure of the vehicle sufficiently free so that the second gas chamber 32 can then be inflated as far as possible without any obstruction. Furthermore, the gas flow enters further into the air bridges 4 and thereby unfolds the first gas chamber 31 into a flat geometry with an unfolded additional fabric layer 8, without the second gas chamber 32 being inflated. Furthermore, the tear seam in the vehicle seat, the B-pillar or the door panel is already torn open to such an extent that the airbag device 19 with the first gas chamber 31 and the second gas chamber 32 exits into the vehicle interior and is arranged between the passenger and the inner side structure of the vehicle before the actual accident occurs. This means that, if the passenger was not previously positioned in a desired position, the passenger can be further pre-positioned. The first gas chamber 31 is deliberately designed to be particularly tight, so that the pressure built up by the first gas generator 7 in the internal volume 3 and in the air bridges 4 is maintained for the longest possible period of approximately 200 ms. The first gas chamber 31 thus holds the second fabric layer 8 in a stretched, unfolded position.

Subsequently, the second gas generator 13 is activated after the occurrence of the accident, i.e. at a time t>0, and generates a gas flow 16, which can be seen in FIG. 7. The second gas generator 13 is preferably designed as a pyrotechnic gas generator and generates a very large gas volume in a very short period of time, which enters the second gas chamber 32 between the fabric layer 8 and the first gas chamber 31 in accordance with the gas flow 16. The second gas chamber 32 is then inflated starting from the unfolded state of the fabric layer 8, without the fabric layers having to unfold. Furthermore, the resulting pressure of up to 2 bar causes the tear seam 11 of the ventilation opening 10 to tear open, so that the gas pressure in the second gas chamber 32 is reduced when the passenger makes contact, resulting in a reduction in the load on the passenger by the gas flow 16 flowing out through the ventilation opening 10, as can be seen in FIG. 9. It is sufficient that the internal pressure is kept above a certain level for only a period of approximately 20 ms during the very short restraint phase.

FIGS. 8 and 9 show the outflow of the gas flow 16 in an alternative embodiment of the airbag device 19. The structure of the airbag device 19 is identical with regard to the design of the first and second gas chambers 31 and 32. The second gas generator 13 is connected here to the second gas chamber 32 via a fabric tube 17 with a tear seam 11, wherein the ventilation opening 10 is arranged in the fabric tube and is already open. The tear seam 11 serves here to release the gas flow 16 into the second gas chamber 32 by tearing open.

The first gas chamber 31 has a significantly smaller gas volume than the second gas chamber 32 and serves to pre-align the second gas chamber 32 before inflation. The second gas chamber 31 has a significantly larger volume and serves to actually restrain the passenger in the event of an accident for a comparatively short period of time of 20 ms. Since the airbag device 19 has already torn open the tear seam in the vehicle seat before the activation of the second gas generator 32 by the inflation of the first gas chamber 21, the second gas generator 13 can be dimensioned significantly smaller with regard to the gas volume to be generated than would be possible without the inflation of the first gas chamber 31 according to the invention.

The two gas chambers 31 and 32 form separate chambers with regard to the inflation process and can thus be designed as systems that are improved with regard to their intended function.

Using the sectional views of FIGS. 6 and 7 in the sectional directions A-A and B-B, FIGS. 10 and 11 show the inflation of the two gas chambers 31 and 32. FIG. 10 shows the gas flow 16 released during the activation of the first gas generator 7, by means of which gas flow the first gas chamber is unfolded in accordance with the procedure described above. As a result, the airbag device 19 is deployed to such an extent that the fabric layer 8, which delimits the second gas chamber 32, is unfolded completely up to the outer edge 12. The second gas generator 13 is then activated thereby releasing a gas flow 16 for inflating the second gas chamber 32, wherein the inflation of the second gas chamber 32 is facilitated in that the fabric layer 8, which delimits the second gas chamber 32, is unfolded by the inflation process of the first gas chamber 31 before the second gas chamber 32 is unfolded up to the outer edge 12.

The first gas chamber 31 is delimited by the two fabric layers 33 and 34, wherein the fabric layer 8 of the second gas chamber 32 abuts the first gas chamber 31, so that overall the airbag device has a three-layer construction. Upon inflation of the first gas chamber 31, the two fabric layers 33 and 34 of the first gas chamber 31 are unfolded and expanded, while the fabric layer 8 of the second gas chamber rests flat against the then middle fabric layer 34. This position can be seen in FIG. 10. After inflation of the first gas chamber 31, the second gas generator 13, as described above, is activated with a time delay thereby releasing a gas flow 16, which can be seen in FIG. 11 and which flows in between the fabric layer 8 and the middle fabric layer 34 thereby inflating the second gas chamber 32.

1. Airbag device for the two-stage deployment of a first and a second gas chamber, comprising
a first system comprising the first gas chamber and a first gas generator which is triggered in a pre-accident situation; and
a second system comprising the second gas chamber and a second gas generator which is triggered in an accident situation; wherein
the first system is configured to fill the first gas chamber with gas by means of the first gas generator, wherein
the second system is configured to fill the second gas chamber with gas by means of the second gas generator.

2. Airbag device according to claim 1, wherein
the first gas chamber has a smaller internal volume than the second gas chamber.

3. Airbag device according to claim 1, wherein
the second gas chamber is formed by sewing a layer to the first gas chamber.

4. Airbag device according to claim 3, wherein
the second gas chamber is connected to the first gas chamber by a seam, wherein
the first gas chamber is formed by a double layer, wherein
the double layer of the first system is used as an additional sealing strip for the first and/or the second gas chamber.

5. Airbag device according to claim 1, wherein
the external geometries of the first gas chamber and the second gas chamber are identical or almost identical.

6. Airbag device according to claim 1, wherein
the first gas generator is a cold gas generator, and/or
the second gas generator is a pyrotechnic gas generator.

7. Airbag device according to claim 1, wherein the airbag device comprises a seat covering and/or a housing, wherein the first and the second gas chamber are arranged in the seat covering and/or within the housing in the deactivated state, wherein
the first system is configured to open the seat covering and/or the housing upon activation, and/or
the first system is configured to pre-deploy the second gas chamber upon activation.

8. Airbag device according to claim 1, wherein
the first gas chamber comprises a plurality of air bridges for the complete pre-deployment of the second gas chamber.

9. Airbag device according to claim 1, wherein
the second gas chamber comprises a valve opening for discharging gas from the second gas chamber.

10. Airbag device according to claim 1, wherein
the first and second gas generators are arranged in the first gas chamber.

11. Airbag device according to claim 1, wherein
the first gas chamber is designed as a single-piece woven structure, and preferably has an inwardly foldable sealing region in a region of the first gas generator assigned to it.

12. Airbag device according to claim 1, wherein
the interior of the second gas chamber is fluidically separated from the environment by a seam, wherein
the second gas chamber is designed in two layers in order to provide additional sealing of the seam by the second layer.

13. Airbag device according to claim 1, wherein
the first gas chamber comprises non-inflatable regions through which a tear seam for the second gas chamber can be placed without affecting the filling of the first gas chamber.

14. Airbag device according to claim 1, wherein
the first gas chamber has non-inflatable regions through which a ventilation opening for the second gas chamber can be placed without affecting the function of the first system.

15. Airbag device according to claim 1, wherein
the second gas chamber has a sealed inlet for the second gas generator, which is additionally designed with a thermal reinforcement layer.

16. Airbag device according to claim 1, wherein
the second gas chamber comprises a ventilation opening which is additionally connected to the first system by a tear seam.

17. Airbag device according to claim 1, wherein
the first and second gas chambers are formed by the same airbag, wherein
the first and second gas chambers are not fluidically connected to one another during the pre-accident phase and the first gas chamber is filled by the first gas generator.

18. Airbag device according to claim 1, wherein
the first and second gas chambers are formed by the same airbag into which both gas generators are integrated, wherein
the second gas generator releases its gas in the event of an accident into a fabric tube, in which a ventilation opening is integrated and which is fluidically separated from the actual second gas chamber by a tear seam, wherein
this tear seam is opened by the resulting pressure wave when the second gas generator is ignited, and then inflates the single airbag with gas.
